(19) United States
(12) Patent Application Publication
(10) Pub. No.: US 2017/0322713 A1
(43) Pub. Date: Nov. 9, 2017

(54) DISPLAY APPARATUS AND METHOD FOR CONTROLLING THE SAME AND COMPUTER-READABLE RECORDING MEDIUM

(71) Applicant: SAMSUNG ELECTRONICS CO., LTD., Suwon-si (KR)

(72) Inventors: Woo-seok HWANG, Seoul (KR); Ji-hyae KIM, Seoul (KR); Mi-youn WON, Seoul (KR); Na-young KOH, Seoul (KR); Hyun-jee KWAK, Seoul (KR); Seung-min LEE, Gwacheon-si (KR); Won-hee LEE, Seoul (KR)

(73) Assignee: SAMSUNG ELECTRONICS CO., LTD., Suwon-si (KR)

(21) Appl. No.: 15/402,697

(22) Filed: Jan. 10, 2017

Related U.S. Application Data
(60) Provisional application No. 62/331,058, filed on May 3, 2016.

(30) Foreign Application Priority Data
Jul. 8, 2016 (KR) 10-2016-0086726

(51) Int. Cl. G06F 3/0484; G06F 3/0481; G06F 3/0482; G06F 3/16; G06F 3/0488

(52) U.S. Cl. CPC G06F 3/04847; G06F 3/165; G06F 3/04883; G06F 3/04817; G06F 3/0482; G06F 3/04845

(57) ABSTRACT

A display apparatus is provided. The display apparatus includes: a communicator configured to communicate with a plurality of speaker devices; a display; and a processor configured to control the display to display a first user interface (UI) element for controlling reproduction on the plurality of speaker devices, a second UI element for individually controlling volumes of each of the plurality of speaker devices and a third UI element for collectively controlling the volumes of the plurality of speaker devices in response to a preset event.

### CROSS-REFERENCE TO RELATED APPLICATIONS

This application claims priority from Korean Patent Application No. 10-2016-0086726, filed on Jul. 8, 2016 in the Korean Intellectual Property Office and the benefit of U.S. Patent Application No. 62/331,058 filed on May 3, 2016 in the USPTO the disclosure of which is incorporated herein by reference in its entirety.

### BACKGROUND

### Field

Apparatuses and methods consistent with exemplary embodiments relate to a display apparatus and a method for controlling the same, and more particularly, to a display apparatus capable of simultaneously controlling volumes of several external speaker devices, a method for controlling the same, and a computer-readable recording medium.

### Description of Related Art

Recently, with the development of communication technologies, a user may control various external devices using a terminal. In particular, a user may construct an audio environment in which an external speaker device is controlled using a terminal.

In detail, recent speaker devices are able to connect to external devices in a wireless manner, and thus may also output sound source content stored in an external server. In addition, the speaker devices may be individually disposed in a plurality of spaces to output the same content or different contents.

However, it is inconvenient to control the volumes of multiple several speaker devices in such an environment, as the volumes of the respective speaker devices need to be individually and repeatedly controlled.

### SUMMARY

Exemplary embodiments overcome the above disadvantages and other disadvantages not described above. Also, exemplary embodiments are not required to overcome the disadvantages described above, and an exemplary embodiment may not overcome any of the problems described above.

According to an aspect of an exemplary embodiment, there is provided a display apparatus including: a communicator configured to communicate with a plurality of speaker devices; a display; and a processor configured to control the display to display a first user interface (UI) element for controlling reproduction on the plurality of speaker devices, a second UI element for individually controlling volumes of each of the plurality of speaker devices and a third UI element for collectively controlling the volumes of the plurality of speaker devices, the second UI element and the third UI element being displayed in response to a preset event.

The processor may be further configured to control the display to display a fourth UI element for selecting a sound source repository, and control the plurality of speaker devices to reproduce a sound source stored in a selected sound source repository.

The processor may be further configured to control the display to display a fifth UI element representing information on sound sources output from the plurality of speaker devices.

The processor may be further configured to control the display to display the fifth UI element over the first UI element.

The processor may be further configured to change a size of the fifth UI element in response to a preset event for the first UI element being generated.

The processor may be further configured to change a size of the first UI element in response to the preset event for the first UI element being generated.

The display apparatus may further include a touch panel configured to sense a touch on the display, and the preset event may be the touch panel sensing a touch on the first UI element and a swipe of the touched first UI element in any one direction while the touch of the first UI element is maintained.

The display apparatus may further include a volume control button disposed on one side surface of the display apparatus, and the preset event may be an operation of the volume control button.

The processor may be further configured to group selected speaker devices in response to a selection of speaker devices from among the plurality of speaker devices, in response to grouping the selection of speaker devices the second UI element may individually control volumes of each of the grouped speaker devices, and in response to grouping the selection of speaker devices the third UI element may collectively control the volumes of the grouped speaker devices.

The processor may be further configured to control the display to display the first UI element in a widget form and a sixth UI element for selection of an application installed on the display apparatus.

According to an aspect of another exemplary embodiment, there is provided a method for controlling a display apparatus, the method including: displaying a first user interface (UI) element for controlling reproduction on a plurality of speaker devices; and in response to a preset event, displaying a second UI element for individually controlling volumes of each of the plurality of speaker devices and a third UI element for collectively controlling the volumes of the plurality of speaker devices.

The method may further include: displaying a fourth UI element for selecting a sound source repository, and controlling the plurality of speaker devices to reproduce a sound source stored in a selected sound source repository.

The may further include displaying a fifth UI element representing information on sound sources output from the plurality of speaker devices.

The fifth UI element may be displayed over the first UI element.

The method may further include changing a size of the fifth UI element in response to a preset event for the first UI element being generated.

The method may further include changing a size of the first UI element in response to the preset event for the first UI element being generated.

The preset event may include sensing a touch on the first UI element and a swipe of the touched first UI element in any one direction while the touch of the first UI element is maintained.

The preset event may be sensing an operation of a volume control button disposed on one side surface of the display apparatus.

The displaying of the first UI element may include displaying the first UI element in a widget form and displaying a sixth UI element for selection of an application installed on the display apparatus.

According to an aspect of yet another exemplary embodiment, there is provided a non-transitory computer readable recording medium including a program, which when executed by a processor of a display apparatus, causes the display apparatus to execute a method for controlling the display apparatus, the method including: displaying a first user interface (UI) element for controlling reproduction on a plurality of speaker devices; and in response to a preset event, displaying a second UI element for individually controlling volumes of each of the plurality of speaker devices and a third UI element for collectively controlling the volumes of the plurality of speaker devices.

### BRIEF DESCRIPTION OF THE DRAWINGS

The above and/or other aspects will be more apparent by describing certain exemplary embodiments with reference to the accompanying drawings, in which:

FIG. 1 is a diagram illustrating a configuration of a sound system according to an exemplary embodiment;

FIG. 2 is a block diagram illustrating a simple configuration of a display apparatus of FIG. 1;

FIG. 3 is a block diagram illustrating a detailed configuration of a speaker device of FIG. 1;

FIG. 4 is a block diagram illustrating a simple configuration of a speaker device of FIG. 1;

FIGS. 5, 6A, 6B, 7A, 7B, 8A, 8B, 9, 10A, 10B, 10C, 10D, 11A, 11B, 11C, 12A, 12B, 13A, 13B, 14A and 14B are diagrams illustrating various examples of a user interface window that may be displayed on a display; and

FIG. 15 is a flow chart for describing a method for controlling a display apparatus according to an exemplary embodiment.

### DETAILED DESCRIPTION OF EXEMPLARY EMBODIMENTS

The present exemplary embodiments may be variously modified and have several forms. Therefore, specific exemplary embodiments will be illustrated in the accompanying drawings and be described in detail in the present specification. However, it is to be understood that the terms such as “include” or “configured” in the present disclosure do not limit features, numerals, and a scope of an exemplary embodiment described in the present specification, but includes all modifications, equivalents, and substitutions without departing from the scope and spirit of the present disclosure. When it is decided that the detailed description of the known art related to the present disclosure may obscure the gist of the present disclosure, a detailed description therefor will be omitted.

Terms ‘first’, ‘second’, and the like, may be used to describe various components, but the components are not to be construed as being limited by the terms. The terms are used only to distinguish one component from another component.

Terms used in the present specification are used only in order to describe specific exemplary embodiments rather than limiting the scope of the present disclosure. Singular forms are intended to include plural forms unless the context clearly indicates otherwise. It is to be understood that the present application specifies the presence of steps, operations, components, parts, or a combination thereof but does not preclude the presence or addition of one or more other features, numerals, steps, operations, components, parts, or a combination thereof.

In the exemplary embodiments, a ‘module’ or a ‘unit’ may perform at least one function or operation, and be implemented by hardware or software or be implemented by a combination of hardware and software. In addition, a plurality of ‘modules’ or a plurality of ‘units’ may be integrated in at least one module and be implemented by at least one processor except for a ‘module’ or a ‘unit’ that needs to be implemented by specific hardware.

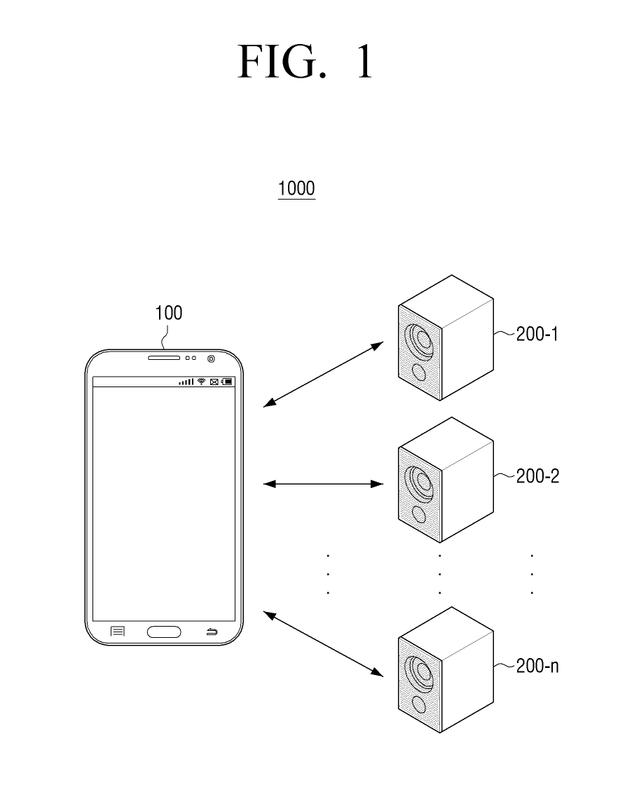

FIG. 1 is a diagram illustrating a configuration of a sound output system according to an exemplary embodiment.

Referring to FIG. 1, a sound output system 1000 includes a display apparatus 100 and a plurality of speaker devices 200-1, 200-2, and 200-n.

The plurality of speaker devices 200-1, 200-2, and 200-n may be disposed in one space but may be disposed even in a separated space by a wall.

Meanwhile, each of the plurality of speaker devices 200-1, 200-2, and 200-n may be connected to an external server and may receive and output sound source content from the external server. In detail, each of the plurality of speaker devices 200-1, 200-2, and 200-n may be pre-registered with reproduction list information or pre-registered with address information. Accordingly, each of the plurality of speaker devices 200-1, 200-2, and 200-n may receive and output the sound source content from the external server based on the pre-registered reproduction list information or address information. Meanwhile, the address information or the reproduction list information stored in each of the speaker devices 200-1, 200-2, and 200-n may be identical or different.

Further, the plurality of speaker devices 200-1, 200-2, and 200-n may output the sound source content stored in the external server in a streaming manner, may download and temporarily store the sound source content, and may also output the temporarily stored sound source content.

Further, each of the plurality of speaker devices 200-1, 200-2, and 200-n may provide apparatus information to the display apparatus 100 and receive a reproduction control command and a volume control command from the display apparatus 100. Here, the apparatus information may include name information of the speaker device, reproduction content information, current volume information, address information, or the like.

Further, each of the plurality of speaker devices 200-1, 200-2, and 200-n may receive the volume control command from the display apparatus 100 and output the sound source content at the volume controlled depending on the received volume control command.

The display apparatus 100 may retrieve the speaker devices 200-1, 200-2, and 200-n connected thereto. Further, the display apparatus 100 may display information on the speaker devices connected thereto, select the plurality of speaker devices for the reproduction control and the volume control among the displayed speaker devices, and receive the volume control operation for one of the plurality of selected speaker devices.

In detail, the display apparatus 100 may display a first UI element that may control a reproduction of sound sources of the plurality of speaker devices 200-1, 200-2, and 200-n. In this case, the first UI element may include a plurality of icons corresponding to at least one of reproduction/pause of the sound source, a reproduction command of previous song and of next song. For example, the first UI element may be a “mini player”, or the like that may control the reproduction of the sound source without being changed to the whole separate window.

Meanwhile, in response to a preset event being generated, the display apparatus 100 may display a second UI element that may individually control the volumes of each of the plurality of speaker devices 200-1, 200-2, and 200-n and a third UI element that may collectively control the volumes of the plurality of speaker devices 200-1, 200-2, and 200-n. In this case, the preset event may be touching the displayed first UI element and swiping the touched first UI element in any one direction or operating a volume control button included in the display apparatus 100.

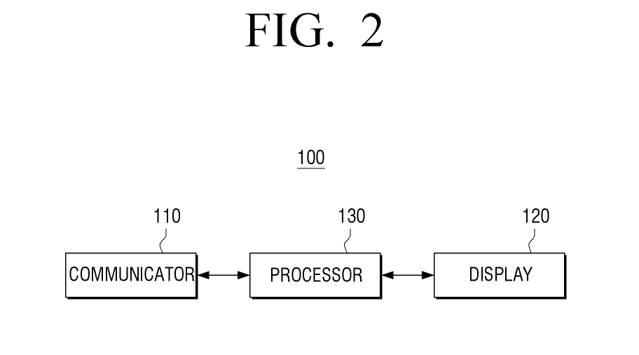

The detailed configuration and operation of the display apparatus 100 will be described below with reference to FIG. 2.

As described above, the sound output system 1000 according to the exemplary embodiment may control the reproduction of the plurality of speaker devices on the display apparatus 100 and easily control the volumes, thereby improving user convenience.

FIG. 2 is a block diagram illustrating a simple configuration of a display apparatus of FIG. 1.

In detail, the display apparatus 100 may be implemented as various types of devices such as TV, a PC, a laptop PC, a cellular phone, a tablet PC, a PDA, an MP3 player, a kiosk, and a digital photo frame. When the display apparatus 100 is implemented as portable apparatuses such as the cellular phone, the tablet PC, the PDA, the MP3 player, and the laptop PC, they may also be called a mobile device but will be commonly called a display apparatus in the present specification.

Referring to FIG. 2, the display apparatus 100 is configured to include a communicator 110, a display 120, and a processor 130.

The communicator 110 may communicate with the plurality of speaker devices located within a network. In detail, the communicator 110 may receive the apparatus information from the plurality of speaker devices connected. Here, the apparatus information may include name information of the speaker device, current volume size information, current reproduction content information, IP address information, or the like.

Further, the communicator 110 may transmit a control command for outputting a sound source of a selected sound source repository to each of the plurality of speaker devices. In this case, the communicator 110 may transmit the control command including the IP address, or the like of the selected sound source repository to the plurality of speaker devices to allow the plurality of speaker devices to receive and output data from the sound source repository selected in a streaming form.

Further, the communicator 110 may transmit a reproduction control command of the sound source to each of the plurality of speaker device selected by a user. In this case, the reproduction control command may be the reproduction/pause, the reproduction of previous song, the reproduction of next song, or the like.

Further, the communicator 110 may transmit the volume control command to each of the speaker devices 200 selected by the user. In this case, the volume control command may be a ‘volume value to be output’ and may also be a ‘value indicating how much the volume is controlled”. For example, the volume of the speaker device may be indicated as a value of 1 to 100 and when the volume of the current specific speaker device is 90 and the volume value controlled by the user is 50, the volume control command may be a command ‘set the volume to be 50’ and may also be a command ‘subtract 40 from the current volume’.

The display 120 may display icons of several applications that are previously installed in the display apparatus 100.

If the icon selected by the user is a speaker device application, the display 120 may display a list for the plurality of speaker devices that may be controlled by the user. In this case, if the user selects any one of the speaker devices, the apparatus information on the speaker device that outputs the same content as the corresponding speaker device may be displayed. Further, when the user selects and groups the plurality of speaker devices to be controlled among the plurality of speaker devices, the display 120 may display the apparatus information on the plurality of grouped speaker devices.

Further, the display 120 may display the first UI element that may control the reproduction of the plurality of speaker devices connected. In detail, the display 120 may display the first UI element in some region of a screen. For example, the first UI element may be displayed in a lower region or an upper region of the screen in a form such as a rectangular bar. In this case, the first UI element may include information on sound sources such as titles of the sound sources output from the plurality of speaker devices and artists and icons that may control at least one of the reproduction/pause, the reproduction of previous song, and the reproduction of next song. Here, if the preset event is generated, the second UI element that may individually control the volumes of the plurality of grouped speaker devices and the third UI element that may collectively control the volumes of the plurality of grouped speaker devices may be further displayed. In this case, the second UI element and the third UI element may consist of bars and pointers movable on the bars but are not limited thereto, and therefore may consist of a plurality of blocks arranged in a row or may have a right-angled triangular shape extending horizontally.

Meanwhile, the exemplary embodiment describes only the case in which if the preset event is generated in the state in which the first UI element is displayed on the display 120, the display 120 further displays the second UI element and the third UI element. However, in the actual implementation, if the preset event is generated even in the state in which the first UI element is not displayed, the display may be implemented in the form in which it displays the second UI element and the third UI element.

In this case, the second UI element and the third UI element may be displayed in a slide manner that as the first UI element moves upwardly, the second UI element and the third UI element are gradually displayed from upper portions thereof, upwardly from the lower portion of the display 120. Meanwhile, a position and a moving direction of the first UI element are not limited, and therefore the direction in which the second UI element and the third UI element are displayed depending on the movement of the first UI element is not limited.

Further, the display 120 may display a fourth UI element for selection of the sound source repository. In detail, the fourth UI element may consist of a plurality of image icons, lists, or the like corresponding to the plurality of external servers and the display apparatus 100, respectively, that are connected to the plurality of speaker devices to provide sound source data.

Further, the display 120 may display a fifth UI element representing the information on the sound sources that are output from the plurality of speaker devices. In this case, the fifth UI element may be an image of an album cover of the output sound source. Meanwhile, the display 120 may display the fifth UI element while the fifth UI element overlays the first UI element. For example, the display 120 may have the form in which an image of some region of the album cover of the output sound source is displayed at a lower portion of the screen in a rectangular bar shape and an icon for the reproduction control of the sound source is displayed on the image of some region of the album cover displayed at the lower portion of the screen while overlaying the image. Meanwhile, in the actual implementation, the display 120 may change a color of the first UI element to a color of the image of the album cover and display the changed color without the image of the album cover of the output sound source overlaying the first UI element.

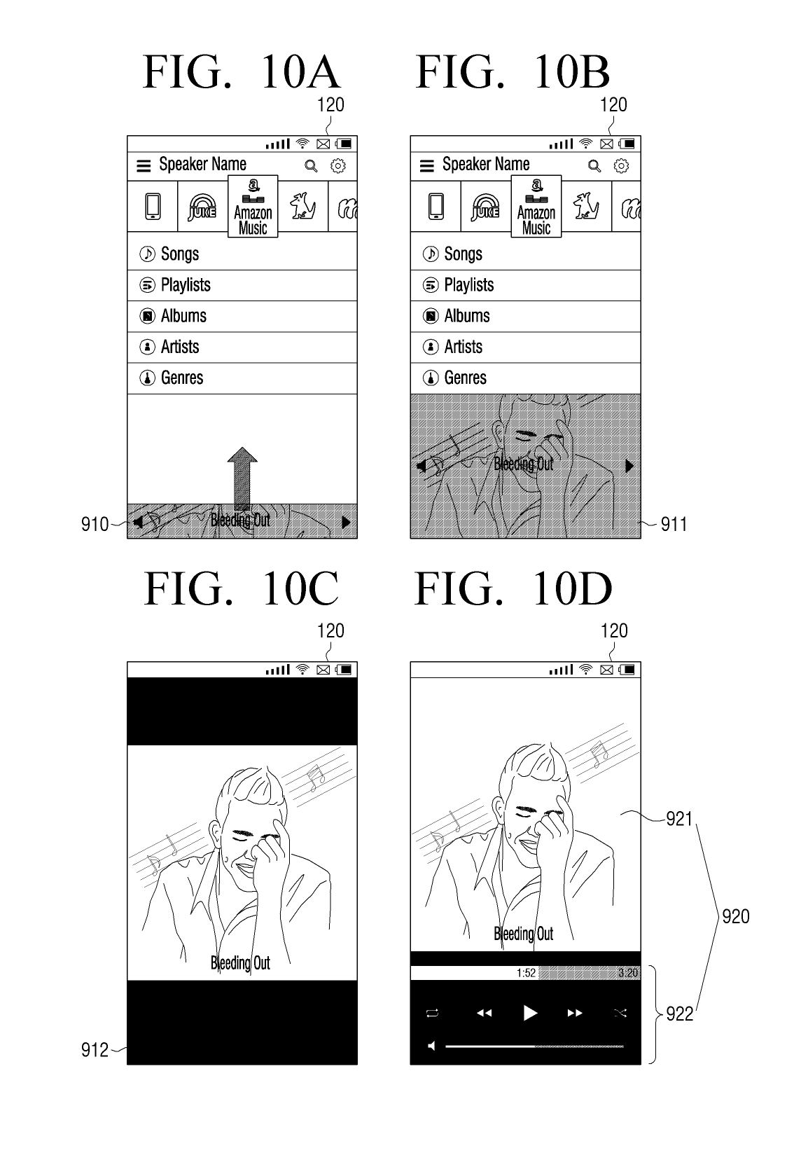

Further, if the preset event for the first UI element is generated, the display 120 may change a size of the fifth UI element and display the fifth UI element. In this case, the preset event may be touching the first UI element by a user, maintaining the touch of the first UI element, and swiping or dragging the first UI element in any one direction that are sensed by a touch panel. For example, when the user touches the first UI element and swipes the first UI element upwardly in the state in which the first UI element is displayed at the lower portion of the screen, the display 120 may display that the size of the album cover of the output sound source is increased according to the operation of the user. In this case, the size of the fifth UI element and the size of the first UI element may be changed together. This will be described in detail with reference to FIG. 10.

On the contrary, when the user touches the upper portion of the screen and swipes the touched upper portion of the screen downwardly in the state in which the album cover of the output sound source is displayed over the whole screen, the display 120 may display that the size of the album cover of the output sound source is reduced according to the operation of the user. By sensing the operation of the user, the size of the first UI element that may control the reproduction as well as the size of the displayed album may be reduced.

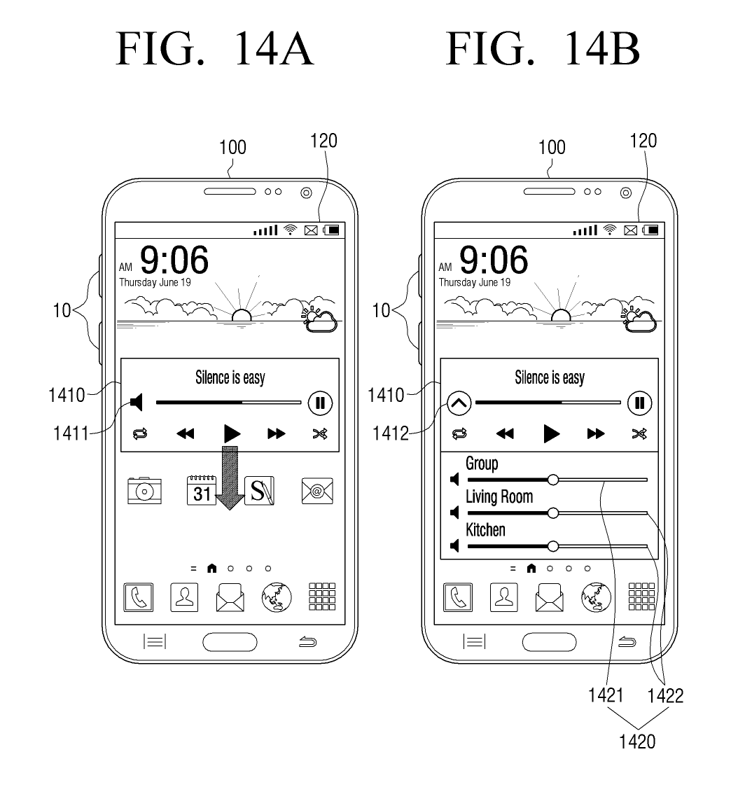

Further, the display 120 may display the first UI element in a widget form while displaying a sixth UI element for selection of applications installed in the display apparatus 100. In this case, the sixth UI element may be a wallpaper or a home screen that is displayed on the display 120 of the display apparatus 100. Further, the widget may mean a mini application that is made to be able to be directly used without passing through a web browser, or the like on the wallpaper. Meanwhile, if the preset event is generated in the state in which the first UI element is displayed in the widget form, the display 120 may further display the second UI element and the third UI element on the wallpaper or the home screen. This will be described in detail below with reference to FIG. 14.

The processor 130 may control the display 120 to display the apparatus information on the connectable speaker devices if the user executes a speaker device application and may group the plurality of selected apparatuses if the plurality of speaker devices to be controlled by the user are selected by the touch panel.

Further, the processor 130 may control the display 120 to further display the first UI element for the reproduction control of the sound sources that are output on the plurality of speaker devices and the second UI element that may individually control the volumes of the plurality of speaker devices connected and the third UI element that may collectively control the volumes of the plurality of speaker devices, in response to the preset event being generated.

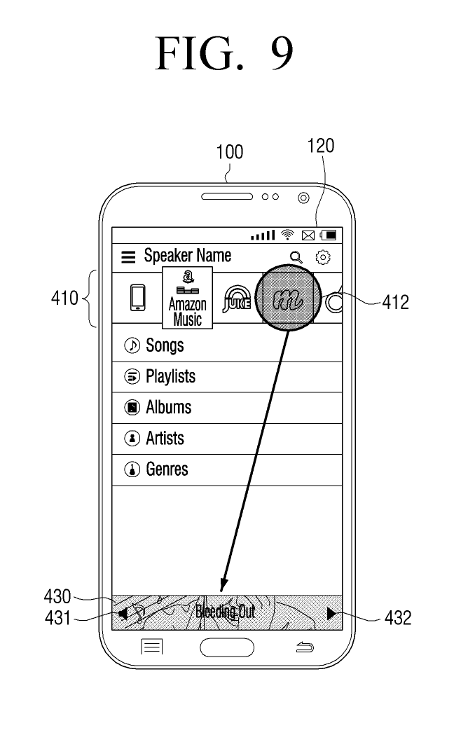

Further, the processor 130 may control the display 120 to display the fourth UI element for the selection of the sound source repository. In this case, the user may select one sound source repository in the fourth UI element. In detail, the user may select the sound source repository in a form that a user touches one sound source repository in the fourth UI element, maintains the touch of the sound source repository, and drags the sound source repository to drop it to the first UI element. Further, the processor 130 may receive the selection of the user through the touch panel and transmit the information on the selected sound source repository to the plurality of speaker devices to enable the plurality of speaker devices to receive and output the sound source data from the selected sound source repository. Meanwhile, when intending to output the sound source to the audio output, the processor 130 may control the communicator 110 to receive the sound source data from the selected sound source repository. This will be described in detail below with reference to FIG. 9.

Further, the processor 130 may control the display 120 to display the fifth UI element representing the information on the sound sources output from the plurality of speaker devices. In detail, the fifth UI element may be the whole or some region of the image of the album cover of the output sound source. Meanwhile, if the preset event for the first UI element is generated, the processor 130 may control the display 120 to change the size of the fifth UI element and display the fifth UI element. Additionally, if the preset event for the first UI element is generated, the processor 130 may control the display 120 to change both of the size of the fifth UI element and the first UI element and display the fifth UI element and the first UI element. This will be described in detail with reference to FIGS. 10 to 12.

Further, the processor 130 may control the display 120 to display the sixth UI element for the selection of the applications installed in the display apparatus 100. In this case, the sixth UI element may be the wallpaper or the home screen that is displayed on the display 120. Meanwhile, the processor 130 may control the display 120 to display the first UI element in the widget form while displaying the sixth UI element. This will be described in detail below with reference to FIG. 14.

The display apparatus 100 according to the exemplary embodiment as described above may individually or collectively control the volumes of the plurality of speaker devices without being changed to a separate window for the control of the volumes of the plurality of speaker devices to be operated by the user, thereby improving the user convenience.

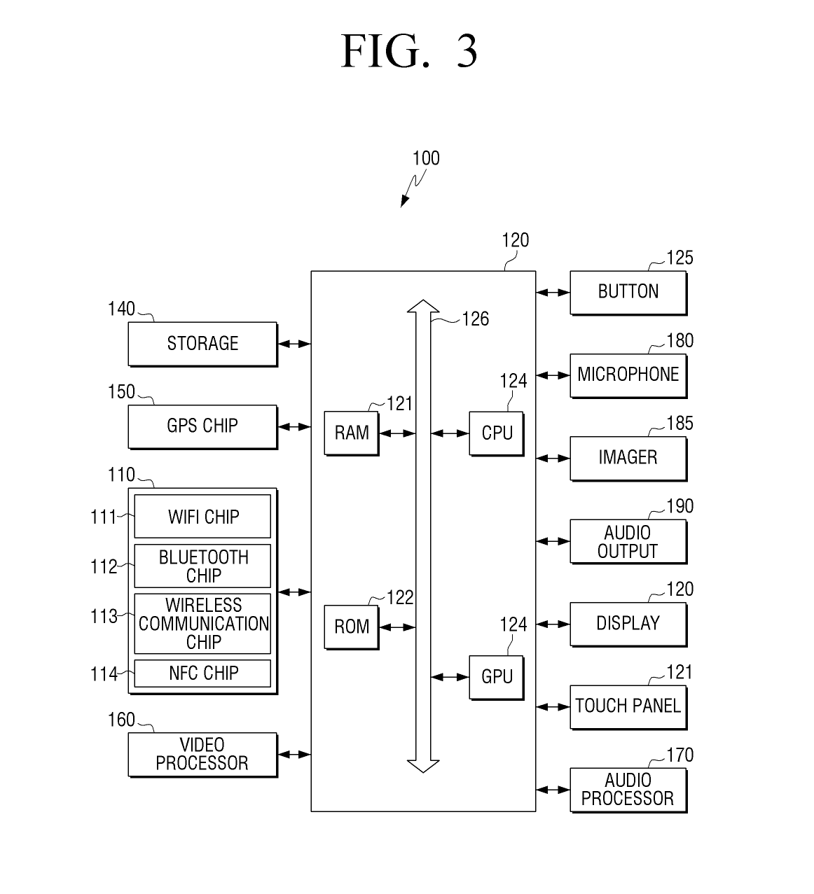

Meanwhile, only the simple components configuring the display apparatus 100 are illustrated and described above, but in the implementation, various components may be additionally provided. This will be described below with reference to FIG. 3.

FIG. 3 is a block diagram illustrating a detailed configuration of the display apparatus of FIG. 1.

Referring to FIG. 3, the display apparatus 100 may be configured to include the communicator 110, the display 120, the processor 130, the storage 140, a GPS chip 150, a video processor 160, an audio processor 170, a button 125, a microphone 180, the imager 185, and an audio output 190.

The communicator 110 is configured to perform communication with various types of external devices according to various types of communication schemes. The communicator 110 includes a WiFi chip 111, a Bluetooth chip 112, a wireless communication chip 113, and an NFC chip 114. The processor 130 uses the communicator 110 to perform communication with various kinds of external devices.

The WiFi chip 111 and the Bluetooth chip 112 each perform communications by a WiFi scheme and a Bluetooth scheme. In the case of using the WiFi chip 111 or the Bluetooth chip 112, various connection information such as an SSID and a session key is first transmitted and received, a communication connection is made using the various connection information, and then various kinds of information may be transmitted and received. The wireless communication chip 113 means a chip which performs communication depending various communication standards such as IEEE, Zigbee, 3rd generation (3G), 3rd generation partnership project (3GPP), long term evolution (LTE), and the like. The NFC chip 114 means a chip which is operated by the NFC scheme using a band of 13.56 MHz among various RF-ID frequency bands such as 135 kHz, 13.56 MHz, 433 MHz, 860 to 960 MHz, and 2.45 GHz.

The display 120 may display the information on the speaker device and display the user interface window for receiving the volume control operation, as described above. The display 120 may be implemented as various forms of displays such as a liquid crystal display (LCD), an organic light emitting diode (OLED) display, and a plasma, display panel (PDP). A driving circuit which may be implemented in forms of an a-si TFT, a low temperature poly silicon (LTPS) TFT, an organic TFT (OTFT), etc., a backlight unit, or the like may be included within the display 120. Further, the display 120 may also be implemented as flexible display.

The touch panel 121 may include a touch sensor for sensing a touch gesture of a user. The touch sensor may be implemented by various types of sensors such as a capacitive type sensor, a resistive type sensor, a piezoelectric type sensor, and the like. The capacitive type uses the scheme of calculating touch coordinates by sensing micro electricity excited to the user's body when some of the user's body is touched on the surface of the touch panel 121, using the dielectric substance coated on the surface of the display. The resistive type uses a scheme of calculating touch coordinates by sensing that a current flows due to a contact between two electrode plates embedded in the touch panel 121 at a touched point when the user touches the screen. In addition, when the display apparatus 100 supports a pen input function, the touch panel 121 may also sense a user gesture using an input means like a pen in addition to a user's finger. When the input means is a stylus pen having a coil included therein, the display apparatus 100 may also include a magnetic field sensing sensor which may sense a magnetic field changed by the coil inside the stylus pen. Therefore, the display apparatus 100 may sense a proximity gesture, that is, hovering as well as the touch gesture.

Meanwhile, it is described that the display function and the gesture sensing function are performed in different configurations, but the display including one touch panel may perform both of the display function and the touch gesture sensing function. That is, the display 120 may also be implemented by combining a display device that may display only an image and a touch panel that may sense only a touch.

The storage 140 may store various programs and data required to operate the display apparatus 100. In detail, the storage 140 may store a program, data, or the like for configuring various UIs configuring the user interface window. Further, the storage 140 may store the information on the speaker device received through the communicator 110.

Further, the storage 140 stores a plurality of applications. Here, at least one application may be the speaker device application for the operations as described in the present disclosure.

The processor 130 uses the program and the data stored in the storage 140 to display the user interface window on the display 120. Further, when a specific region of the user interface window is touched by a user, the processor 130 performs a control operation corresponding to the touch.

The processor 130 includes a RAM 131, a ROM 132, a CPU 133, a graphic processing unit (GPU) 134, and a bus 135. The RAM 131, the ROM 132, the CPU 133, the GPU 134, etc., may be connected to each other through the bus 135.

The CPU 133 accesses the storage 140 to perform booting using an O/S stored in the storage 140. Further, the CPU executes various operations using various programs, contents, data, and the like which are stored in the storage 140.

The ROM 132 is stored with a set of commands for system booting. When a turn on command is input and thus power is supplied, the CPU 133 copies an O/S stored in the storage 140 to the RAM 131 according to the command stored in the ROM 132 and executes the O/S to boot the system. If the booting is completed, the CPU 133 copies the various programs stored in the storage 140 to the RAM 131 and executes the programs copied to the RAM 131 to execute various operations.

When the booting of the display apparatus 100 is completed, the GPU 134 displays the UI on the display. In detail, the GPU 134 may use an operator and a renderer to generate a screen including various objects such as an icon, an image, and a text. The operator operates attribute values, such as coordinate values at which each object will be displayed and forms, sizes, and colors of each object, according to a layout of the screen. The renderer generates a screen of various layouts including an object based on the attribute values that are operated by the operator. The screen (or user interface window) generated on the renderer is provided to the display 120 to be displayed on a main display region and a sub display region, respectively.

The GPS chip 150 is a component for receiving a global positioning system (GPS) signal from a GPS satellite to calculate a current position of the display apparatus 100. The processor 130 may use the GPS chip 150 to calculate a user position when a navigation program is used or the current position of the user is required.

The video processor 160 is a component for processing video data which are included in contents received through the communicator 110 or contents stored in the storage 140. The video processor 160 may perform various image processings, such as decoding, scaling, noise filtering, frame rate conversion, and resolution conversion, on the video data.

The audio processor 170 is a component for processing audio data which are included in contents received through the communicator 110 or contents stored in the storage 140. The audio processor 170 may perform various processings such as decoding, amplification, and noise filtering on the audio data.

When a playing application for multimedia contents is executed, the processor 130 may drive the video processor 160 and the audio processor 170 to play the corresponding contents. In this case, the display 120 may display an image frame generated from the video processor 160 on at least one of a main display region and a sub display region.

The audio output 190 outputs the audio data generated from the audio processor 170.

The button 125 may be various types of buttons such as a mechanical button, a touch pad, and a wheel which are formed in any region such as a front portion, a side portion, a rear portion, etc., of an appearance of a main body of the display apparatus 100. The button 125 may include the volume control button that may be disposed at the side portion of the appearance of the main body to control the volume. In detail, the button 125 may include a ‘+’ button receiving a command to increase the volume and a ‘−’ button receiving a command to decrease the volume.

The microphone 180 is a component for receiving a user voice or other sounds and converting the received user voice or other sounds into the audio data. The processor 130 may use the user voice input through the microphone 180 during a call process or convert the user voice into the audio data and store the converted audio data in the storage 140. Meanwhile, the microphone 180 may be implemented as a stereo microphone that receives a sound input from several positions.

The imager 185 is a component for imaging a still image or a moving image depending on the control of the user. The imager 185 may be implemented in plural, like a front camera and a rear camera. As described above, the imager 185 may be used as a means for acquiring a user image in the exemplary embodiment for tracking the user eyes.

When the imager 185 and the microphone 180 are provided, the processor 130 may also perform the control operation depending on the user voice input through the microphone 180 or a user motion recognized by the imager 185. That is, the display apparatus 100 may be operated in a motion control mode or a voice control mode. When the display apparatus 100 is operated in the motion control mode, the processor 130 activates the imager 185 to image the user and tracks the motion change of the user to perform the control operation corresponding thereto. When the display apparatus 100 is operated in the voice control mode, the processor 130 may also be operated in a voice recognition mode that analyzes the user voice input through the microphone 180 and performs the control operation depending on the analyzed user voice.

In the display apparatus 100 supporting the motion control mode or the voice control mode, a voice recognition technology or a motion recognition technology may be used in various exemplary embodiments as described above. For example, if the user takes a motion like selecting the object displayed on the home screen or pronounces a voice command corresponding to the object, it is determined that the corresponding object is selected and the control operation matched with the object may be performed.

In addition, according to the exemplary embodiment, the display apparatus 100 may further include an USB port to which an USB connector may be connected, external input ports connected to various external terminals such as a headset, a mouse, and an LAN, a DMB chip receiving and processing a DMB signal, various sensors, etc.

Meanwhile, as described above, the storage 140 may store various programs.

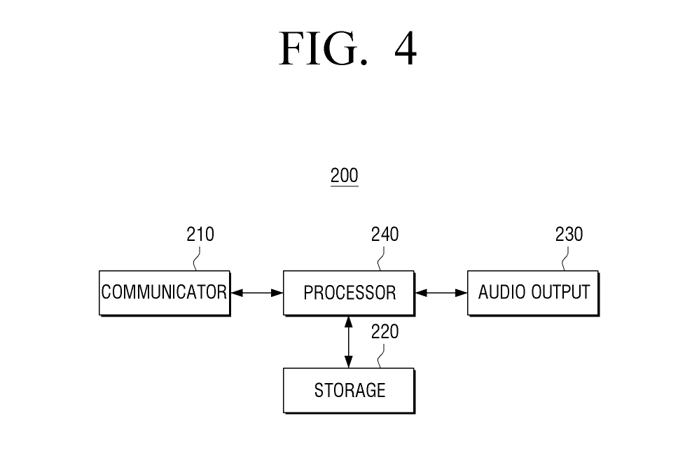

FIG. 4 is a block diagram illustrating a simple configuration of a speaker device of FIG. 1.

Referring to FIG. 4, the speaker device 200 is configured to include a communicator 210, a storage 220, an audio output 230, and a processor 240.

The communicator 210 may transmit the apparatus information on the speaker device 200 to the display apparatus located within the network. Further, the communicator 210 may receive the information on the sound source repository and various control commands such as a reproduction control command and a volume control command.

Further, the communicator 210 may communicate with an external server that corresponds to the sound source repository providing the sound source data. In detail, when receiving the information on the sound source repository receiving the sound source from the display apparatus, the communicator 210 may transmit the sound source providing request to the corresponding sound source repository and receive the sound source data from the sound source repository.

The storage 220 may store the information on the speaker device 200. In detail, the information on the speaker device 200 may be the name of the speaker device, the current volume size information, the current reproduction content information, the IP address, or the like.

Further, the storage 220 may temporarily or continuously store the information on the sound source repository and the control command received from the display apparatus and the sound source data received from the sound source repository.

The audio output 230 may output the sound source data received from the sound source repository through the communicator 210.

The processor 240 may control each component of the speaker device 200. In detail, the processor 240 may transmit the information on the speaker device 200 stored in the storage 140 to the display apparatus through the communicator 210 and receive the information on the sound source repository for providing the sound source from the display apparatus.

Further, the processor 240 may use the information on the sound source repository received through the communicator 210 to request the transmission of the sound source data to the corresponding sound source repository and control the audio output 230 to output the received sound source data.

Meanwhile, the speaker device 200 may further include the display, the touch panel, or the like depending on the implementation form.

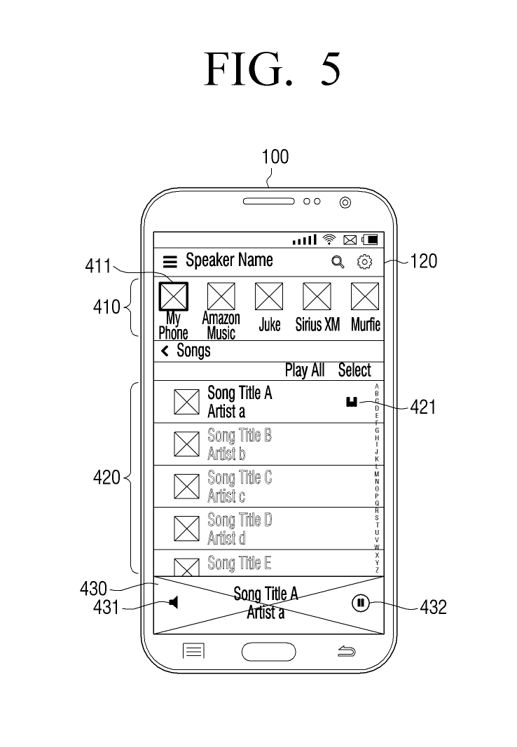

FIG. 5 is a diagram illustrating an example of the user interface window that may be displayed on the display 120 when the display apparatus 100 according to the exemplary embodiment executes the speaker device application.

Referring to FIG. 5, the display 120 may display a fourth UI element 410 representing the selectable sound source repository, a reproducible sound source list 420, and a first UI element 430 for a reproduction control. In this case, the first UI element 430 may be displayed at a lower portion of the display 120 in a rectangular bar shape. However, the first UI element 430 is not limited thereto and may also be displayed at an upper portion or a side surface of the display 120.

Further, a user may select an icon 411 corresponding to the display apparatus 100 in the fourth UI element 410 representing a plurality of sound source repositories, and thus the reproducible sound source list 420 may consist of sound sources stored in the display apparatus 100.

In this case, the first UI element may include an icon 431 that may control the volume and an icon 432 that may control the reproduction. Here, referring to FIG. 5, the icon 432 that may control the reproduction is an icon representing a pause, and therefore it may be appreciated that ‘Song Title A’ is currently being reproduced. Further, the first UI element may be selected from the reproducible sound source list 420 and may display the information on a sound source 421 that is being reproduced. In this case, the information on the sound source 421 that is being reproduced may include a title, an artist, or the like of the sound source.

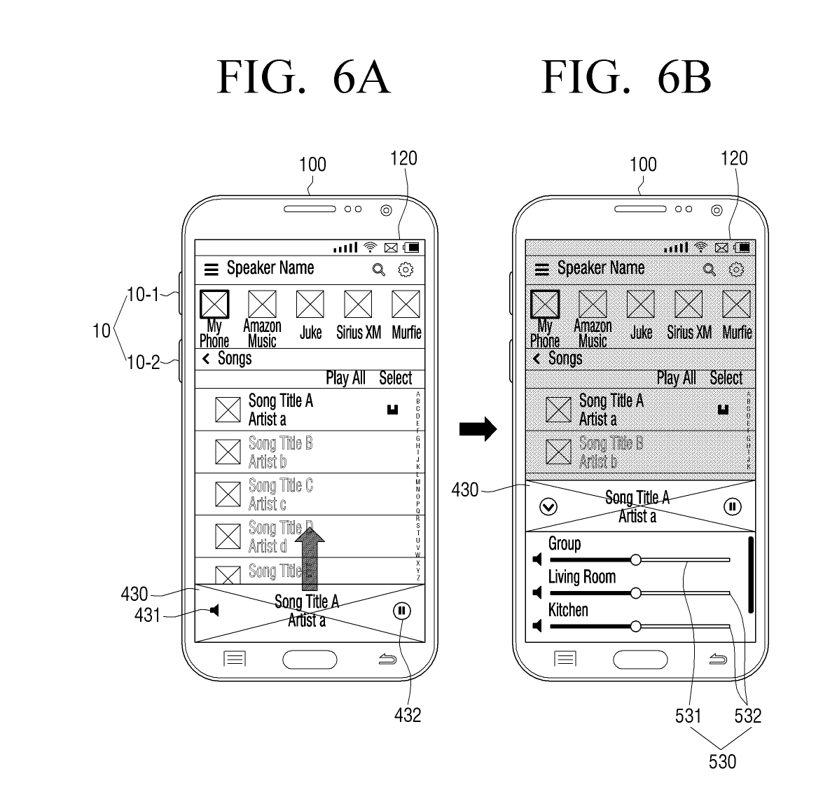

FIGS. 6A and 6B are diagrams illustrating an example of the user interface window that may be displayed when the preset event is generated in the state in which the user interface window illustrated in FIG. 5 is displayed on the display 120 of the display apparatus 100.

Referring to FIG. 6A, the display apparatus 100 may include the display 120 and a volume control button 10 disposed on one side surface thereof. In detail, the display 120 may display the first UI element 430 that may control the reproduction of the plurality of speaker devices connected to the display apparatus 100. In this case, the first UI element 430 may include the icon 431 that may control the volume and the icon 432 that may control the reproduction.

Further, the volume control button 10 may include a ‘+’ button 10-1 that may increase the volume of the output sound source and a ‘−’ button 10-2 that may decrease the volume.

In this case, if the preset event is generated, as illustrated in FIG. 6B, the user interface window may be displayed. In detail, when the user touches the first UI element 430, maintains the touch of the first UI element 430 and swipes the touched first UI element 430 upwardly, or operates at least one of the volume control buttons or when the user touches the icon 431 that may control the volume, as illustrated in FIG. 6B, a UI element 530 that may control the volumes of the plurality of speaker devices may be further displayed together with the first UI element 430 that may control the reproduction of the plurality of speaker devices.

In this case, the UI element 530 including a second UI element 531 and a third UI element 532 may be displayed in the slide manner that as the first UI element 430 moves upwardly, the UI element 530 is gradually displayed from an upper portion thereof, upwardly from the lower portion of the display 120.

Meanwhile, the UI element 530 that may control the volumes of the plurality of speaker devices may be further displayed, and thus the icon 431 which may control the volume and is included in the first UI element 430 may be changed to an icon form that may close the UI element 530 that may control the volumes of the plurality of speaker devices.

In detail, the UI element 530 that may control the volumes of the plurality of speaker devices may include the second UI element 531 that may collectively control the volumes of the plurality of speaker devices and the third UI element 532 that may individually control the volumes of the plurality of speaker devices. In this case, the third UI element 532 that is displayed to individually control the volumes of the speaker devices may be all the plurality of speaker devices connected to the display apparatus 100 or the plurality of speaker devices grouped by the selection of the user.

The display apparatus 100 according to the exemplary embodiment as described above may individually or collectively control the volumes of the plurality of speaker devices without being changed to a separate window for the control of the volumes of the plurality of speaker devices to be operated by the user, thereby improving the user convenience.

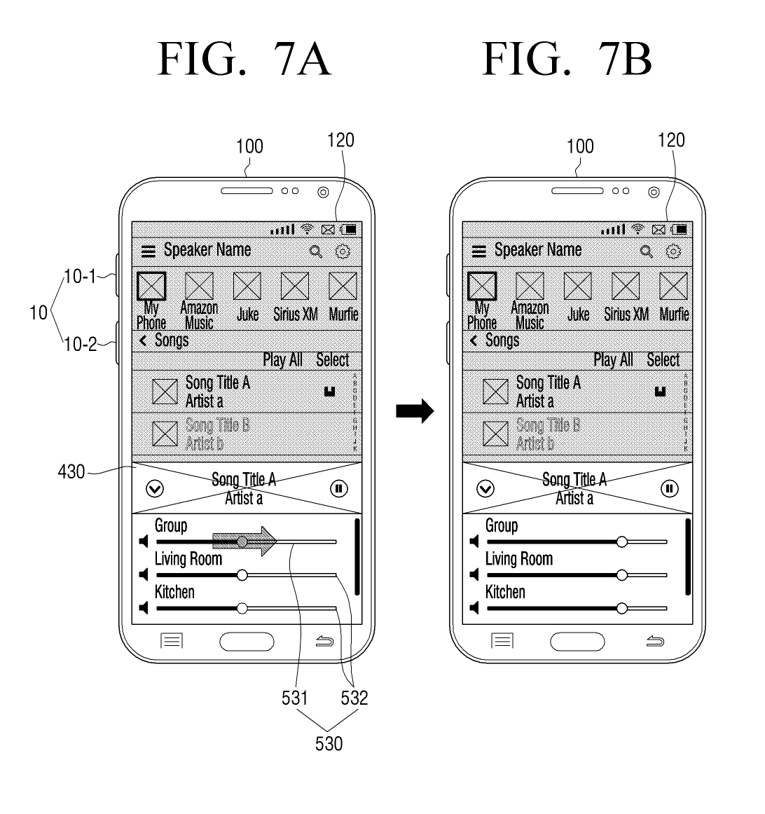

FIGS. 7A and 7B are diagrams illustrating an example of the user interface window that may be displayed at the time of receiving the operation of collectively controlling the volumes of the plurality of speaker devices from the user.

Referring to FIG. 7A, the display apparatus 100 may include the display 120 and the volume control button 10 including the ‘+’ button 10-1 that may increase the volume of the sound source and the ‘−’ button 10-2 that may decrease the volume, in which the ‘+’ button 10-1 and the ‘−’ button 10-2 being provided on one side surface thereof.

In detail, the display 120 may display the UI element 530 including the second UI element 531 that may collectively control the volumes of the plurality of speaker devices and the third UI element 532 that may individually control the volumes of the plurality of speaker devices, along with the first UI element 430 that may control the reproduction of the plurality of speaker devices connected to the display apparatus 100.

In this case, if the preset event is generated, as illustrated in FIG. 7B, the display 120 may display the second UI element 531 and the third UI element 532 of which a pointer moves. In this case, the pointer may represent the volumes of the plurality of speaker devices.

For example, if the user moves the pointer of the second UI element 531 to the right or presses the ‘+’ button 10-1, the display 120 may perform a display to move the pointer of the third UI element 532 that may individually control the volumes of the plurality of speaker devices as well as the pointer of the second UI element 531 that may collectively control the volumes of the plurality of speaker devices to the right. Meanwhile, the display apparatus 100 may transmit the command to increase the volume to each of the plurality of speaker devices according to the operation of the user.

Meanwhile, if the user moves the pointer of the second UI element 531 to the left or presses the ‘−’ button 10-2, the display 120 may perform a display to move the pointer of the third UI element 532 as well as the pointer of the second UI element 531 to the left. Meanwhile, the display apparatus 100 may transmit the command to decrease the volume to each of the plurality of speaker devices according to the operation of the user.

The display apparatus 100 according to the exemplary embodiment as described above may collectively control the volumes of the plurality of speaker devices without being changed to a separate window for the control of the volumes of the plurality of speaker devices to be operated by the user, thereby improving the user convenience.

Meanwhile, when the user moves each of the pointers of the third UI element 532, the volumes of each of the speaker devices may also be individually controlled.

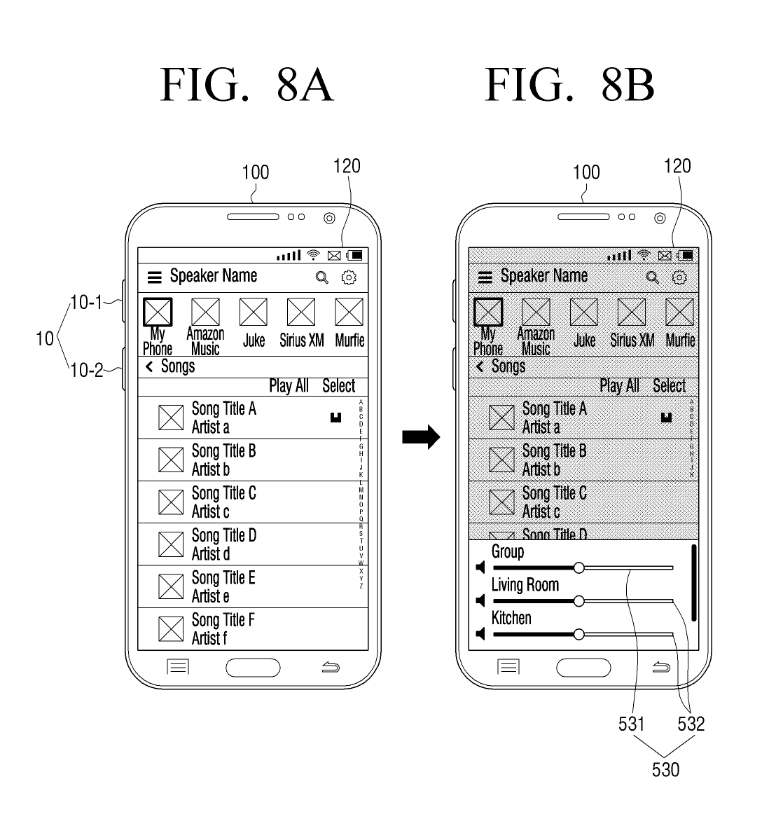

FIGS. 8A and 8B are diagrams illustrating an example of the user interface window that may be displayed, if the preset event is generated in the state in which the sound source is not reproduced.

Referring to FIG. 8A, the display apparatus 100 may include the display 120 and the volume control button 10 including the ‘+’ button 10-1 that may increase the volume of the sound source and the ‘−’ button 10-2 that may decrease the volume, in which the ‘+’ button 10-1 and the ‘−’ button 10-2 being provided on one side surface thereof.

In detail, if the user executes the speaker device application, the display 120 may display the images of the plurality of sound source repositories and the plurality of sound sources provided from the selected sound source repository.

Meanwhile, if the preset event is generated even when the display 120 does not display the first UI element that may control the reproduction of the plurality of speaker devices, for example, even when the user does not select the sound source to be reproduced among the plurality of sound sources provided or even when the user interface window does not consist of the first UI element, as illustrated in FIG. 8B, the display 120 may display the UI element 530 including the second UI element 531 and the third UI element 532.

In detail, when the user touches the lower portion of the display 120, maintains the touch and swipes the touched lower portion of the display 120 upwardly, or operates at least one of the volume control buttons, as illustrated in FIG. 8B, the display 120 may further display the UI element 530 including the second UI element 531 and the third UI element 532 that may control the volumes of the plurality of speaker devices.

In this case, the UI element 530 including the second UI element 531 and the third UI element 532 may be displayed in the slide manner that the UI element 530 is gradually displayed from the upper portion thereof, upwardly from the lower portion of the display 120.

Even in the state in which the sound source is not reproduced, the display apparatus 100 according to the exemplary embodiment as described above may individually or collectively control the volumes of the plurality of speaker devices without being changed to a separate window for the control of the volumes of the plurality of speaker devices to be operated by the user, thereby improving the user convenience.

FIG. 9 is a diagram illustrating an example of the user interface window that may be displayed to select the sound source repository providing the sound source by the user.

Referring to FIG. 9, the display 120 of the display apparatus 100 according to the exemplary embodiment may display the fourth UI element 410 for selecting the sound source by the user and the first UI element 430 for the reproduction control of the plurality of speaker devices.

In detail, the fourth UI element 410 may include a plurality of image icons corresponding to the plurality of sound source repositories that may be connected to the plurality of speaker devices to provide the sound sources to each of the plurality of speaker devices. In this case, the fourth UI element 410 may include the display apparatus 100 as the sound source repository.

For example, when the user selects any one sound source repository in the fourth UI element 410, the display apparatus 100 may control the plurality of speaker devices to receive and output the sound source data from the selected sound source repository.

In detail, when touching an image 412 corresponding to any one sound source repository in the fourth UI element 410 or maintaining the touch of the image 412 and dragging the touched image 412 to be dropped on the first UI element 430, the display apparatus 100 may recognize that any one sound source repository in the fourth UI element 410 is selected.

After selecting the sound source repository that provides the sound source, the display apparatus 100 may control the plurality of speaker devices to output the sound source stored in the selected sound source repository. For example, the display apparatus 100 may control the plurality of speaker devices to reproduce a first sound source in the sound source list stored in the selected sound source repository or reproduce the sound source that is reproduced most recently.

Meanwhile, the user may use the icon 431 that may control the volume included in the first UI element 430 and the icon 432 that may control the reproduction to control the volume and reproduction of the plurality of speaker devices that are receiving the sound source from the selected sound source repository and outputting the sound source.

The display apparatus 100 according to the exemplary embodiment as described above may change the sound source repository without being changed to a separate window for the control of the volumes of the plurality of speaker devices to be operated by the user, thereby improving the user convenience.

FIGS. 10A to 10D are diagrams illustrating the user interface window representing a process of changing, by a user, a mini player to the overall player.

Referring to FIG. 10A, if the user executes the speaker device application, the display 120 may display the first UI element, which may control the reproduction of the plurality of speaker devices, at the lower portion thereof. In this case, the first UI element may be the mini player that may control the reproduction of the plurality of speaker devices without opening the separate reproduction control window. In this case, the display 120 may display a fifth UI element 910 representing the information on the sound sources that are being output from the plurality of speaker devices. Here, the information on the sound source may be the album cover of the output sound source and the fifth UI element 910 displayed on the display 120 may be displayed while overlaying the first UI element. In this case, the fifth UI element 910 that is displayed while overlaying the first UI element may be some region of the album cover of the output sound source, depending on the size of the first UI element.

In this case, if the user touches the first UI element which the fifth UI element 910 overlays and maintains the touch of the first UI element and swipes or drags the touched first UI element in an arrow direction, as illustrated in FIGS. 10B to 10D, the display 120 may display fifth UI elements 911, 912, and 921 to gradually increase a size thereof. Meanwhile, the center of gravity of a region may gradually rise while a size of the region in which the fifth UI element is displayed is increased in the display 120.

For example, if the user touches the first UI element which the fifth UI element 910 overlays and maintains the touch of the first UI element and swipes or drags the touched first UI element up to the upper portion of the display 120 or up to the preset position, not the upper portion of the display 120, as illustrated in FIGS. 10B to 10D, the size of the fifth UI element may also be gradually increased.

Referring to FIG. 10D, the display 120 may display the whole player UI 920 according to the operation of the user. In detail, the whole player UI 920 may include a fifth UI element 921 corresponding to the whole of the album cover that is the information on the reproduced sound source and a control UI 922 that may control the reproduction and volume of the plurality of speaker devices. In this case, the control UI 922 included in the whole player UI 920 may be the first UI element of which the size is changed. In detail, if the preset event for the first UI element is generated, the size of the fifth UI elements 910, 911, 912, and 921 is changed and the size of the first UI element may also be changed.

The example in which the size of the fifth UI element is increased is just illustrated and described above, but if the user touches the upper portion of the whole player UI 920 illustrated in FIG. 10D and swipes or drags the touched upper portion of the whole player UI 920 up to the lower portion thereof, the example in which the size of the fifth UI element is decreased while the user interface windows illustrated in FIGS. 10A to 10D are progressed in an inverse order may be implemented.

The display apparatus 100 according to the exemplary embodiment as described above may implement the mini player and the whole player in the slide manner without being changed to the separate window, thereby making the operation of the user more convenient.

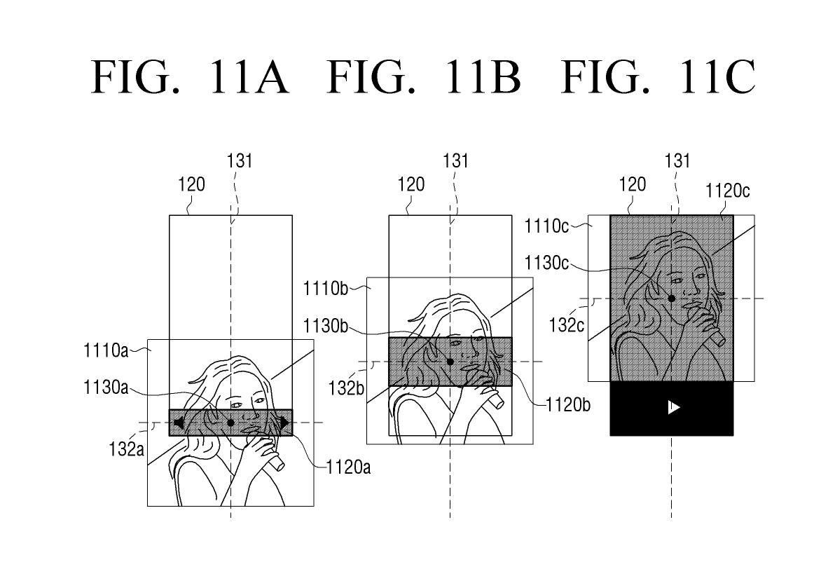

FIGS. 11A to 11C are diagrams illustrating the example of determining the region in which the fifth UI element is displayed according to the operation of the user as illustrated in FIGS. 10A to 10D.

In detail, FIG. 11A illustrates the region in which the fifth UI element is displayed when the plurality of speaker devices are controlled by the mini player, FIG. 11B illustrates the region in which the fifth UI element is displayed when the mini player is changed to the whole player by the operation of the user, and FIG. 11C illustrates the region in which the fifth UI element is displayed when the plurality of speaker devices are controlled by the whole player.

According to the exemplary embodiment, the region to be displayed on the display 120 as the fifth UI element in the whole image of the album cover is determined in the state in which the whole image of the album cover and the region in which the fifth UI element will be displayed on the display 120 share a center of gravity.

In detail, referring to FIG. 11A, the whole image 1110a of the album cover of the reproduced sound source and a region 1120a in which the fifth UI element will be displayed on the display 120 may share a center of gravity 1130a. In this case, the center of gravity 1130a may be a cross point of a vertical line 131 with a horizontal line 132a. Here, the vertical line 131 may vertically bisect whole image 1110a of the album cover and the region 1120a in which the fifth UI element will be displayed so that the whole image 1110a and the region 1120a have a left and right symmetry and the horizontal line 132a may vertically bisect the whole image 1110a of the album cover and the region 1120a in which the fifth UI element will be displayed so that the whole image 1110a and the region 1120a have an up and down symmetry.

Meanwhile, as illustrated in FIG. 11A, when the plurality of speaker devices are controlled by the mini player, the display 120 may display the control UI controlling the plurality of speaker devices while the control UI overlays the fifth UI element.

Further, by the operations of the user such as the swipe and the drag, the size of the region in which the fifth UI element will be displayed on the display 120 may be gradually increased and the center of gravity may gradually move.

In detail, referring to FIG. 11B, the whole image 1110b of the album cover of the reproduced sound source and a region 1120b in which the fifth UI element will be displayed on the display 120 may share a center of gravity 1130b. In this case, the center of gravity 1130b may move above the center of gravity 1130a illustrated in FIG. 11A. In this case, the center of gravity 1130b may be a cross point of the vertical line 131 with a horizontal line 132b. Here, the description of the vertical line 131 and the horizontal line 132b is the same as that of the vertical line 131 and the horizontal line 132a of FIG. 11A, and therefore the detailed description thereof will be omitted.

Further, referring to FIG. 11C, the whole image 1110c of the album cover of the reproduced sound source and a region 1120c in which the fifth UI element will be displayed on the display 120 may share a center of gravity 1130c. In this case, the center of gravity 1130c may move above the center of gravity 1130B illustrated in FIG. 11B. In this case, the center of gravity 1130c may be a cross point of the vertical line 131 with a horizontal line 132c. Here, the description of the vertical line 131 and the horizontal line 132c is the same as that of the vertical line 131 and the horizontal line 132a of FIG. 11A, and therefore the detailed description thereof will be omitted.

Meanwhile, as illustrated in FIG. 11C, when the plurality of speaker devices are controlled by the whole player, the display 120 may separately display the control UI controlling the plurality of speaker devices from the whole image of the album cover.

The display apparatus 100 according to the exemplary embodiment as described above may implement the mini player and the whole player in the slide manner without being changed to the separate window, thereby making the operation of the user more convenient and providing the aesthetically improved user interface window to the user.

Meanwhile, the example in which the region to be displayed as the fifth UI element in the whole image of the album cover is determined by the scheme in which the whole image of the album cover and the region in which the fifth UI element will be displayed on the display 120 share the center of gravity is described, but in the actual implementation, by the swipe or drag operation of the user, the region to be displayed may also be implemented in the slide manner that the region to be displayed is gradually widened in an opposite direction of the swipe or the drag while one end of the album cover starts to be displayed.

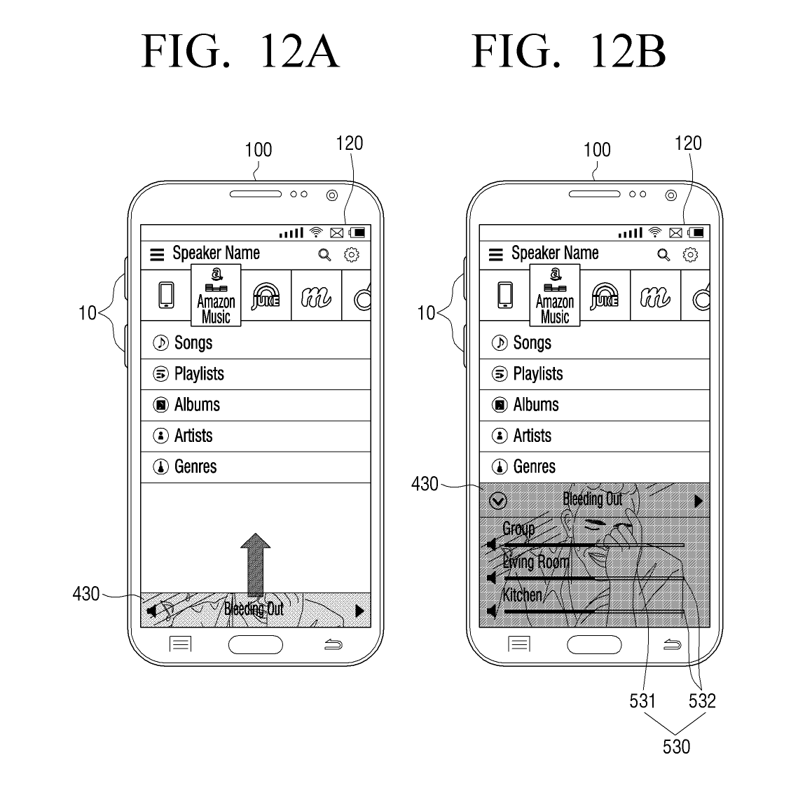

FIGS. 12A and 12B are diagrams illustrating an example of the user interface window that may be displayed when the preset event is generated in the state in which the user interface window illustrated in FIG. 10A is displayed on the display 120 of the display apparatus 100.

Referring to FIG. 12A, the display apparatus 100 may include the display 120 and a volume control button 10 disposed on one side surface thereof. In detail, the display 120 may display the first UI element 430 that may control the reproduction of the plurality of speaker devices connected to the display apparatus 100. In this case, the first UI element 430 may include the icon that may control the volume and the icon that may control the reproduction. Further, the display 120 may further display the fifth UI element representing the information on the sound sources that are output from the plurality of speaker devices. In detail, the display 120 may display some region of the album cover of the output sound source as the fifth UI element while some region of the album cover overlays the first UI element 430.

In this case, if the preset event is generated, as illustrated in FIG. 12B, the user interface window may be displayed. In detail, when the user touches the first UI element 430, maintains the touch of the first UI element 430 and swipes the first UI element 430 upwardly, or operates at least one of the volume control buttons 10 or when the user touches the icon that may control the volume, as illustrated in FIG. 12B, a UI element 530 that may control the volumes of the plurality of speaker devices may be further displayed together with the first UI element 430 that may control the reproduction of the plurality of speaker devices.

In this case, if the preset event for the first UI element 430 is generated, the display 120 may display the fifth UI element of which the size is changed depending on the generated event. In detail, a region wider than some region of the album cover displayed while some region of the album cover overlays the first UI element 430 may be displayed as the fifth UI element while overlaying the first UI element 430 and the UI element 530 that may control the volume of the plurality of speaker devices.

The display apparatus 100 according to the exemplary embodiment as described above may individually or collectively control the volumes of the plurality of speaker devices without being changed to a separate window for the control of the volumes of the plurality of speaker devices to be operated by the user, thereby improving the user convenience and providing the aesthetically improved user interface window to the user.

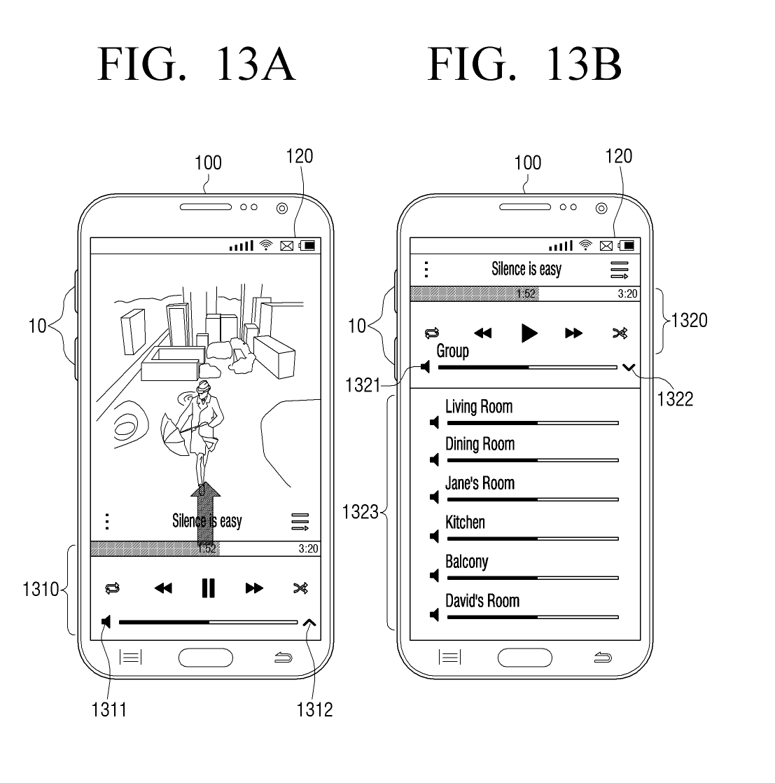

FIGS. 13A and 13B are diagrams illustrating the user interface window that may be displayed if the preset event is generated, when the plurality of speaker devices are controlled by the whole player.

Referring to FIG. 13A, the display apparatus 100 may include the display 120 and a volume control button 10 disposed on one side surface thereof. In detail, the display 120 may display the whole image of the album cover of the sound sources output from the plurality of speaker devices and a control UI 1310 that may control the reproduction of the plurality of speaker devices. In this case, the control UI 1310 that may control the reproduction may include an icon 1311 that may control the volume and an icon 1312 that may display the third UI element that may individually control the volumes of the plurality of speaker devices. Here, when the volumes are controlled using the icon 1311 that may control the volumes, the volumes of the plurality of speaker devices connected may be collectively controlled.

In this case, if the preset event is generated, as illustrated in FIG. 13B, a third UI element 1323 that may individually control the volumes of the plurality of speaker devices may be further displayed.

In detail, when the user touches the control UI 1310, maintains the touch of the control UI 1310 and swipes the touched control UI 1310 upwardly, or operates at least one of the volume control buttons 10 or when the user touches the icon 1312 that may display the third UI element that may individually control the volumes of the plurality of speaker devices, as illustrated in FIG. 13B, the third UI element 1323 that may individually control the volumes of the plurality of speaker devices may be further displayed along with the control UI 1310 that may control the reproduction of the plurality of speaker devices and the second UI element 1321 that may collectively control the volumes of the plurality of speaker devices. In this case, as the third UI element 1323 is displayed by the operation of the user, the icon 1312 that may display the third UI element may be changed to the icon 1322 that may remove the third UI element.

The display apparatus 100 according to the exemplary embodiment as described above may individually or collectively control the volumes of the plurality of speaker devices without being changed to a separate window for the control of the volumes of the plurality of speaker devices to be operated by the user, thereby improving the user convenience.

FIGS. 14A and 14B are diagrams illustrating an example of the user interface window that may be displayed on the display 120 when the preset event is generated on the wallpaper or the home screen of the display apparatus 100 according to the exemplary embodiment.

Referring to FIG. 14A, the display apparatus 100 may include the display 120 and a volume control button 10 disposed on one side surface thereof.

The display 120 may display a first UI element 1410 that may control the reproduction of the plurality of speaker devices while displaying a sixth UI element for the selection of the plurality of applications installed in the display apparatus 100. In this case, the sixth UI element may be the wallpaper or the home screen of the display apparatus 100 and the first UI element 1410 may be displayed in the widget form. Here, the first UI element 1410 may include an icon 1411 that may control the volume.

In this case, if the preset event is generated, as illustrated in FIG. 14B, the user interface window may be displayed. In detail, when the user touches the first UI element 1410, maintains the touch of the first UI element 1410 and swipes the touched first UI element 1410 downwardly, or operates at least one of the volume control buttons 10 or when the user touches an icon 1411 that may control the volume, as illustrated in FIG. 14B, a UI element 1420 that may control the volumes of the plurality of speaker devices may be further displayed together with the first UI element 1410 that may control the reproduction of the plurality of speaker devices.

In this case, the UI element 1420 including the second UI element 1421 that may collectively control the volumes of the plurality of speaker devices and the third UI element 1422 that may individually control the volumes of the plurality of speaker devices may be displayed in the slide manner that the UI element 1420 is gradually displayed from a lower portion thereof, downwardly from the lower portion of the first UI element 1410.

Meanwhile, the UI element 1420 that may control the volumes of the plurality of speaker devices may be further displayed, and thus the icon 1410 which may control the volume and is included in the first UI element 1411 may be changed to an icon 1412 that may close the UI element 1420 that may control the volumes of the plurality of speaker devices.

In detail, the UI element 530 that may control the volumes of the plurality of speaker devices may include the second UI element 531 that may collectively control the volumes of the plurality of speaker devices and the third UI element 532 that may individually control the volumes of the plurality of speaker devices. In this case, the third UI element 532 that is displayed to individually control the volumes of the speaker devices may be all the plurality of speaker devices connected to the display apparatus 100 or the plurality of speaker devices grouped by the selection of the user.

The display apparatus 100 according to the exemplary embodiment as described above may individually or collectively control the volumes of the plurality of speaker devices without being changed to a separate window for the control of the volumes of the plurality of speaker devices to be operated by the user, thereby improving the user convenience.

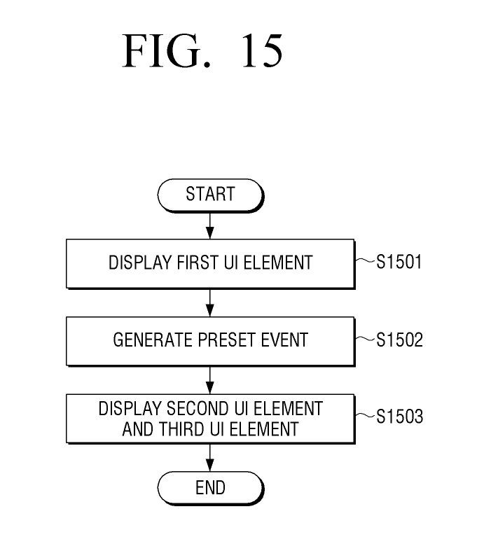

FIG. 15 is a flow chart for describing a method for controlling a display apparatus according to an exemplary embodiment.

First, the user may execute the speaker device applications. Further, the user may select the sound source to be reproduced.

Therefore, the display apparatus may display the first UI element (S1501). In detail, the display apparatus may display the first UI element that may control the reproduction of the plurality of speaker devices connected. In this case, the first UI element may include the icon that may control the reproduction of the plurality of speaker devices and the icon that may control the volume. Here, when the volumes are controlled using the icon that may control the volumes, the volumes of the plurality of speaker devices connected may be collectively controlled.

Next, the display apparatus may sense that the preset event is generated (S1502). In detail, when the user touches the first UI element, maintains the touch of the first UI element and swipes the touched first UI element in any one direction, or operates any one of the volume control buttons installed in the display apparatus, the display apparatus may sense that the icon that may control the volume is touched.

If it is sensed that the preset event is generated, the display apparatus may display the second UI element and the third UI element (S1503). In detail, the display apparatus may further display the second UI element that may collectively control the volumes of the plurality of speaker devices and the third UI element that may individually control the volumes of the plurality of speaker devices, along with the first UI element that may control the reproduction of the plurality of speaker devices. Meanwhile, the second UI element and the third UI element that may control the volumes of the plurality of speaker devices are further displayed, and thus the icon that may control the volume and is included in the first UI element may be changed to the icon that may close the second UI element and the third UI element that may control the volumes of the plurality of speaker devices.

The display apparatus according to the exemplary embodiment as described above may individually or collectively control the volumes of the plurality of speaker devices without being changed to a separate window for the control of the volumes of the plurality of speaker devices to be operated by the user, thereby improving the user convenience. The volume control method as illustrated in FIGS. 11A to 11C may be carried out on the display apparatus having the configuration of FIG. 2 or 3 and may also be carried out on the display apparatus having other configurations.

Further, the volume control method as described above may be implemented by at least one execution program (or application) for executing the volume control method as described above and the execution program may be provided while being stored in a computer readable medium.

The non-transitory computer readable medium is not a medium that stores data therein for a while, such as a register, a cache, and a memory, but means a medium that semi-permanently stores data therein and is readable by a device. In detail, various applications or programs described above may be stored and provided in the computer readable medium such as a compact disk (CD), a digital versatile disk (DVD), a hard disk, a Blu-ray disk, a universal serial bus (USB), a memory card, and a read only memory (ROM).

Although exemplary embodiments have been illustrated and described hereinabove, the present disclosure is not limited to the above-mentioned specific exemplary embodiments, but may be variously modified by those skilled in the art to which the present disclosure pertains without departing from the scope and spirit of the disclosure as disclosed in the accompanying claims. These modifications should also be understood to fall within the scope of the present disclosure.

What is claimed is:

1. A display apparatus comprising:
a communicator configured to communicate with a plurality of speaker devices;
a display; and
a processor configured to control the display to display a first user interface (UI) element for controlling reproduction on the plurality of speaker devices, a second UI element for individually controlling volumes of each of the plurality of speaker devices and a third UI element for collectively controlling the volumes of the plurality of speaker devices,
wherein the second UI element and the third UI element are displayed in response to a preset event.

2. The display apparatus as claimed in claim 1, wherein the processor is further configured to control the display to display a fourth UI element for selecting a sound source repository, and control the plurality of speaker devices to reproduce a sound source stored in a selected sound source repository.

3. The display apparatus as claimed in claim 1, wherein the processor is further configured to control the display to display a fifth UI element representing information on sound sources output from the plurality of speaker devices.

4. The display apparatus as claimed in claim 3, wherein the processor is further configured to control the display to display the fifth UI element over the first UI element.

5. The display apparatus as claimed in claim 3, wherein the processor is further configured to change a size of the fifth UI element in response to a preset event for the first UI element being generated.

6. The display apparatus as claimed in claim 5, wherein the processor is further configured to change a size of the first UI element in response to the preset event for the first UI element being generated.

7. The display apparatus as claimed in claim 1, further comprising a touch panel configured to sense a touch on the display,
wherein the preset event is the touch panel sensing a touch on the first UI element and a swipe of the touched first UI element in any one direction while the touch of the first UI element is maintained.

8. The display apparatus as claimed in claim 1, further comprising a volume control button disposed on one side surface of the display apparatus,
wherein the preset event is an operation of the volume control button.

9. The display apparatus as claimed in claim 1, wherein the processor is further configured to group selected speaker devices in response to a selection of speaker devices from among the plurality of speaker devices,
in response to grouping the selection of speaker devices, the second UI element individually control volumes of each of the grouped speaker devices, and
in response to grouping the selection of speaker devices, the third UI element collectively control the volumes of the grouped speaker devices.

10. The display apparatus as claimed in claim 1, wherein the processor may be further configured to control the display to display the first UI element in a widget form and a sixth UI element for selection of an application installed on the display apparatus.

11. A method for controlling a display apparatus, the method comprising:
displaying a first user interface (UI) element for controlling reproduction on a plurality of speaker devices; and
in response to a preset event, displaying a second UI element for individually controlling volumes of each of the plurality of speaker devices and a third UI element for collectively controlling the volumes of the plurality of speaker devices.

12. The method as claimed in claim 11, further comprising:
displaying a fourth UI element for selecting a sound source repository, and
controlling the plurality of speaker devices to reproduce a sound source stored in a selected sound source repository.

13. The method as claimed in claim 11, further comprising displaying a fifth UI element representing information on sound sources output from the plurality of speaker devices.

14. The method as claimed in claim 13, wherein the fifth UI element is displayed over the first UI element.

15. The method as claimed in claim 13, further comprising changing a size of the fifth UI element in response to a preset event for the first UI element being generated.

16. The method as claimed in claim 15, further comprising changing a size of the first UI element in response to the preset event for the first UI element being generated.

17. The method as claimed in claim 11, wherein the preset event comprises sensing a touch on the first UI element and a swipe of the touched first UI element in any one direction while the touch of the first UI element is maintained.

18. The method as claimed in claim 11, wherein the preset event is sensing an operation of a volume control button disposed on one side surface of the display apparatus.

19. The method as claimed in claim 11, wherein the displaying of the first UI element comprises displaying the first UI element in a widget form and displaying a sixth UI element for selection of an application installed on the display apparatus.

20. A non-transitory computer readable recording medium including a program, which when executed by a processor of a display apparatus, causes the display apparatus to execute a method for controlling the display apparatus, the method including:
displaying a first user interface (UI) element for controlling reproduction on a plurality of speaker devices; and
in response to a preset event, displaying a second UI element for individually controlling volumes of each of the plurality of speaker devices and a third UI element for collectively controlling the volumes of the plurality of speaker devices.
